(19) United States
(12) Patent Application Publication
(10) Pub. No.: US 2016/0346573 A1
(43) Pub. Date: Dec. 1, 2016

(54) LITHIUM BATTERY FIRE SUPPRESSION WATER HOSE SYSTEM

(71) Applicants: Bradley Dean Carson, Menifee, CA (US); Dale Elliott Carson, Menifee, CA (US)

(72) Inventors: Bradley Dean Carson, Menifee, CA (US); Dale Elliott Carson, Menifee, CA (US)

(21) Appl. No.: 14/942,113

(22) Filed: Nov. 16, 2015

Related U.S. Application Data
(60) Provisional application No. 62/169,497, filed on Jun. 1, 2015.

(51) Int. Cl. A62C 3/07; A62C 35/60; A62C 3/16

(52) U.S. Cl. CPC A62C 3/07; A62C 3/16; A62C 35/60

(57) ABSTRACT

Improvements in a lithium battery fire suppression water hose system is disclosed. The system uses a connection to a vehicle that allows first responders to connect to the vehicle and release fire suppressant material into the vehicle into a location that is most susceptible to fire. The connection is accessible from a port located on the exterior of the vehicle and may further include additional instructions. The connection does not simply dump material into the vehicle, but routs around internal components of the vehicle to distribution heads that are tuned to provide varying amounts of fire suppressing material to different parts of the vehicle and or battery compartment. The connection is pressurized by the vehicle or house to push water chemicals or other fire suppressing media. The system may distribute Nobel or other gases to remove or displace oxygen and starve the fire of oxygen.

### CROSS REFERENCE TO RELATED APPLICATIONS

This application claims the benefit of Provisional Application Ser. No. 62/169,497 filed Jun. 1, 2015 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the Invention

This invention relates to improvements in a lithium battery fire suppression water hose system. More particularly, the present fire suppression system is a connection on the outside of a car that uses a manifold of piping to direct water to a battery pack within the car.

Description of Related Art Including Information Disclosed Under 37 CFR 1.97 and 1.98.

When a buses, truck or specialty vehicle catches fire, first responders are not only challenged with understanding how to access vehicle components that are burning, they are challenged with fighting that fire in a safe and effective manner.

While first responder training for these specialty vehicles is sometimes employed to educate fire fighters, the explosive growth in vehicle technologies is making such training impractical. Indeed, first responders are presently challenged with understanding not only how to fight an engine fire and brake fires, but battery fires on hybrid and electrical vehicles. Complicating the need to understand how to combat various fires, the firefighter is challenged with knowing how to best access the various volatile components.

Car designs have evolved to include hybrid cars that operate with a combination of gas and electric power as well as cars that operate entirely from energy stored in batteries. Batteries store large amounts of energy and when a failure occurs the batteries can become extremely hot and catch fire. The fire is often started deep within the vehicle. As the fire burns the failure can cause a cascading problem until the entire battery pack melts. The quickest way to extinguish the fire is to place cooling water or fire extinguishing media directly on the fire and into the hot area of the fire. Because electric and hybrid cars have become a recent advancement in vehicles, the safety to extinguish a battery fires are found in few patents and patent publications.

A number of patents and or publications have been made to address these issues. Exemplary examples of patents and or publication that try to address this/these problem(s) are identified and discussed below.

Published U.S. Patent application Number 20110108293 published on May 12, 2011 to Markku Vuorisalo et al., disclose a Fire Fighting System. The fire-fighting system comprising a fixed fire-fighting system with a plurality of spray heads as well as means for leading a fire fighting medium from a fire fighting medium source to the spray heads as well as at least one pump means between the fire-fighting medium source and the spray heads, which system further comprises spray heads arranged in a mobile unit, such as a vehicle, a carriage connectable to a vehicle, a train or a train car, and means for leading a fire fighting medium to the spray heads. This fire-fighting system distributes water throughout the entire vehicle to extinguish a fire within the entire vehicle. While it will extinguish the fire it will cause damage to the entire vehicle.

U.S. Pat. No. 5,826,663 issued on Oct. 27, 1998 to Goran Sundholm disclose A System for Fighting Fires. The object of the invention is to provide a new fire protection system for hotels, office buildings, industrial plants or whole communities. The unit which is to be protected is provided with an automatic fire fighting installation preferably operated by high pressure hydraulic accumulators, for initial fighting of a fire in order to at least suppress the fire. Water is distributed to the entire building to extinguish a fire. This patent also distributes water throughout the entire building and not a particular area where a fire will generally start.

What is needed is a battery fire extinguishing system for a vehicle. The proposed disclosure providing a connection point for fire hoses that directs the extinguishing agent that vehicle engineers have determined to be high risk locations to extinguish a fire in the batteries within a vehicle.

### BRIEF SUMMARY OF THE INVENTION

It is an object of the lithium battery fire suppression water hose system to provide a connection to a vehicle that allows first responders to connect to the vehicle and release fire suppressant material into the vehicle into a location that is most susceptible to fire. The connection is accessible from a port located on the exterior of the vehicle and may further include additional instructions for connecting and may include optimal fire suppressing instructions for fighting the fire. The connection may further include an interlock to prevent accidental or unintentional access.

It is an object of the lithium battery fire suppression water hose system to utilize a Manifold that directs fire suppressing media to the locations where they will be the most effective. The connection does not simply dump material into the vehicle, but the manifold connects from the external connection port and routs around internal components of the vehicle to distribution heads that are tuned to provide varying amounts of fire suppressing material to different parts of the vehicle and or battery compartment. Optimizing distribution of fire suppressing material will not only provide optimal fire suppression, but will also reduce damage to other parts of the vehicle and will not distribute material to the occupants that can cause harm to people.

It is another object of the lithium battery fire suppression water hose system for the externally connected device to be powered. In a fire, the vehicle electrical system can be completely ineffective to fight a fire by operating pumps of other systems. The connection is pressurized by the vehicle or house to push water chemicals or other fire suppressing media. It is also contemplated that in an enclosed system Nobel or other gases can be distributed within the battery compartment or the vehicle to remove or displace oxygen and starve the fire of oxygen.

It is still another object of the lithium battery fire suppression water hose system to have a return system. The return system can collect fire suppressing media or cooling water that would otherwise fall through the vehicle. The collection of the fire suppressing material allows for continued flushing of cooling material that might become simply “packed” within the vehicle.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows an exterior of an electric or hybrid vehicle with a lithium battery fire suppression water hose system.

FIG. 2 shows the manifold for fire suppression of a battery pack.

### DETAILED DESCRIPTION OF THE INVENTION

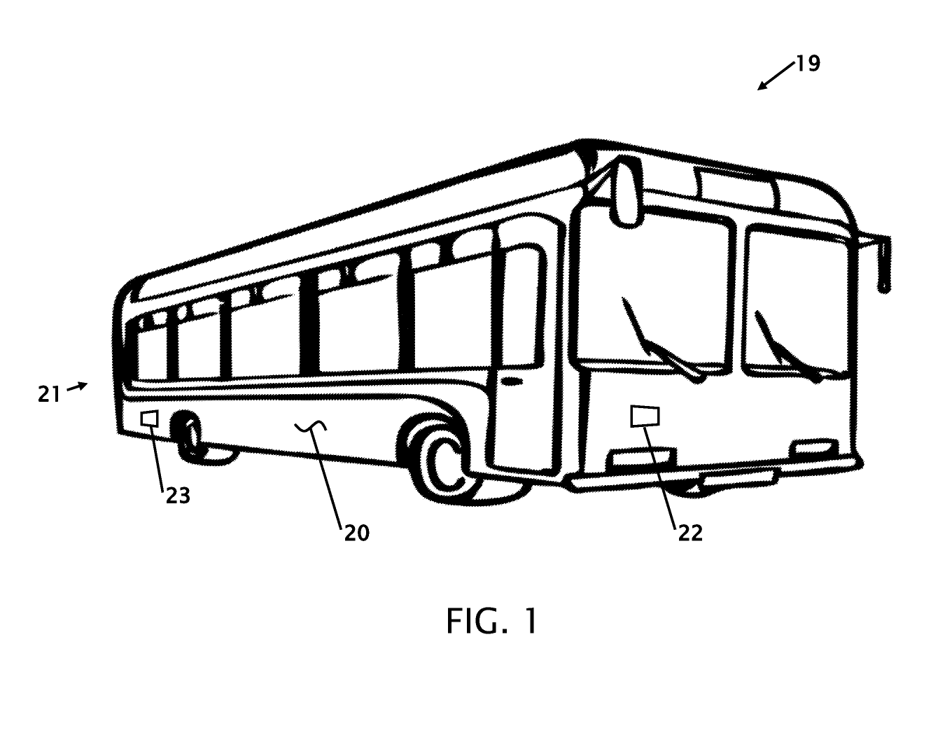

FIG. 1 shows an exterior of an electric or hybrid vehicle 19 with a lithium battery fire suppression water hose system. This vehicle 19 has batteries that are distributed within the vehicle 19. Batteries are found in the front 20 of the vehicle 19 and in the rear of the vehicle 21. Separate access ports 22 and 23 allow for external connection to each or both of the access ports 22 and 23. The lithium battery fire suppression water hose system allows first responders to combat vehicle fires in a safe and uniform manner. The a lithium battery fire suppression water hose system uses a port 22 and or 23 located on a vehicle 19 that provides a connection point for fire hoses that directs the extinguishing agent that vehicle engineers have determined to be high risk locations. The port 22 and or 23 is protected by a flap or other protected opening that distinguishes the lithium battery fire suppression water hose port from accidental access that could foul the port when needed. The port can open with a magnetic closure or some similar locking mechanism that does not require power, key or other mechanism that could be fouled when the access is needed.

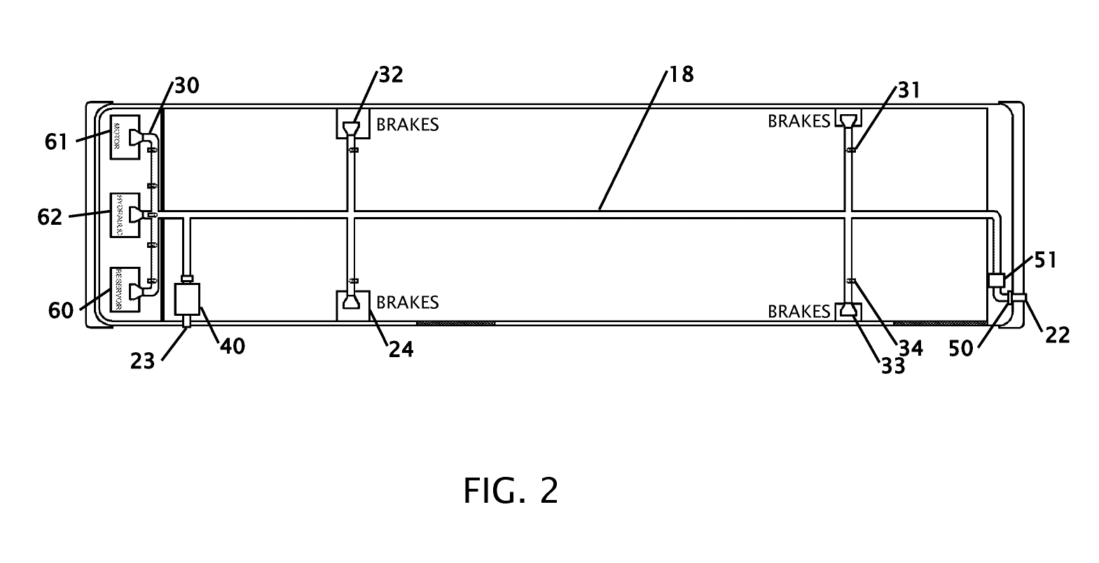

FIG. 2 shows the manifold for fire suppression of a battery pack 24. Once the access port is opened the fire-fighter activates the fire extinguishing process. The activation provides an interlock that vehicle engineers can use to secure electrical power to a connector 50. The external electrical power is separate from the normal vehicle electrical system. This electrical system can evaluate hot areas within the vehicle and can open or close a valve 41 or valves or diverters to direct fire suppressing material to a particular area the most needs the cooling and or fire suppression. In this figure, the manifold 18 has four feed tubes that distribute the fire suppressant within and around the battery pack 24. The power can close valves for volatile liquids or gases that can be harmful to the people trying to extinguish the fire or to the environment.

The valves can help to dispense Nobel or other gases that can be distributed within the battery compartment or the vehicle to remove or displace oxygen and starve the fire of oxygen. It is further contemplated that the fire suppressing media can be carrier with the vehicle and the support vehicle can simply provide air or pressure to push the fire suppressing media where it is most need. The fire-fighting support system releases onboard auxiliary chemical agents to reduce the risk of the fire spreading. A reservoir 40 of fires suppressing material may be contained within the vehicle where it can flow through the manifold 18 to distribute fire suppressing material into and around the battery pack 24 and or battery compartment.

The lithium battery fire suppression water hose system differs from existing onboard fire suppression system in that they are “one chance” devices. In the event of an engine fire, the suppression system will indeed release an agent. However, the simple release of that agent does not always extinguish the fire and if it does, there is a significant risk of re-ignition. The manifold 18 has a plurality of different dispensing heads. It is contemplated that the different dispensing heads can include a spray head 32 with multiple openings 33, side openings 31 and focusing nozzles 34 that emit fire suppressing material to specific locations.

In the preferred embodiment, a vehicle will have a universal vehicle fire nozzle inlet connection 23 and manifold 30 that reduces the complexity and risk of fighting fires in buses, trucks or specialty vehicles. The lithium battery fire suppression water hose system turns this complex and risky task into a three step process. The first step, when a fire-fighter reaches a vehicle, the fire-fighter will open the access door or connection lid. In the second step, the fire-fighter will attach the fire hose. In the final step, the fire-fighter will apply the fire extinguishing agent into the access port.

Once access into the port is established, the fire fighter will find a fire hose connection point where the fire fighter can connect a fire hose for dispensing water or other fire extinguishing media. The manifold 30 allows the vehicle engineers or fire fighters to supply extinguishing agent to high risk areas with suitable pipes and nozzles. An interlock switch 51 allows the vehicle engineers or fire fighters to enhance safety by securing power, isolating gas or liquid flow, or trigger the release of onboard firefighting agents 40. The manifold 30 is further ported to other parts of the vehicle including, but not limited to, the reservoir 60, the motor 61 and the hydraulics 62.

Thus, specific embodiments of a lithium battery fire suppression water hose system have been disclosed. It should be apparent, however, to those skilled in the art that many more modifications besides those described are possible without departing from the inventive concepts herein. The inventive subject matter, therefore, is not to be restricted except in the spirit of the appended claims.

### SEQUENCE LISTING

Not Applicable.

1. A lithium battery fire suppression water hose system comprising:
a vehicle;
said vehicle having an access port located on an exterior of said vehicle;
said access port being connected to a manifold;
said manifold having a plurality of pipes and nozzles;
said nozzle being directed into a battery compartment within said vehicle.

2. The lithium battery fire suppression water hose system according to claim 1 wherein said access port has an interlock switch.

3. The lithium battery fire suppression water hose system according to claim 2 wherein said interlock switch provides at least one of a list consisting of securing power, isolating gas, isolating liquid flow, and triggering a release of onboard firefighting agents.

4. The lithium battery fire suppression water hose system according to claim 1 further includes a recovery system for recovering fire extinguishing media from said vehicle.

5. The lithium battery fire suppression water hose system according to claim 1 wherein said interlock switch activates dispersion of fire suppressing media from a vehicle mounted reservoir.

6. The lithium battery fire suppression water hose system according to claim 1 wherein said manifold further directs fire suppression media to brakes of said vehicle.

7. The lithium battery fire suppression water hose system according to claim 1 wherein said manifold further directs fire suppression media to a hydraulic system of said vehicle.

8. The lithium battery fire suppression water hose system according to claim 1 wherein at least a second access port is located on said vehicle.

9. The lithium battery fire suppression water hose system according to claim 8 wherein said at least a second access port is located on a different side of said vehicle from said first access port.

10. The lithium battery fire suppression water hose system according to claim 8 wherein said first and said at least a second access port are both connected to said manifold.

11. The lithium battery fire suppression water hose system according to claim 1 wherein said interlock switch further includes a selection or control to direct fire suppressing water to be directed to a specified are of said vehicle.

12. The lithium battery fire suppression water hose system according to claim 1 wherein said interlock further includes instructional information.

13. The lithium battery fire suppression water hose system according to claim 1 wherein said interlock prevents accidental or unintentional access.

14. The lithium battery fire suppression water hose system according to claim 1 wherein said nozzles direct fire suppressing media to a specific location of said vehicle.

15. The lithium battery fire suppression water hose system according to claim 1 wherein said manifold is tuned to provide varying amounts of fire suppressing material to different parts of said vehicle.

16. The lithium battery fire suppression water hose system according to claim 1 wherein that further includes distribution heads that are tuned to provide varying amounts of fire suppressing material to different parts of said vehicle.

17. The lithium battery fire suppression water hose system according to claim 1 wherein fire suppressing media is a Nobel gas.

18. The lithium battery fire suppression water hose system according to claim 4 wherein said recovery provides continuous flushing of fire suppressing media.

19. The lithium battery fire suppression water hose system according to claim 1 wherein said nozzle being directed into a battery compartment directs fire suppressing media over and around batteries.

20. The lithium battery fire suppression water hose system according to claim 1 wherein said access port is accessed with a magnetic closure.
